(19) United States
(12) Patent Application Publication
(10) Pub. No.: US 2025/0289257 A1
(43) Pub. Date: Sep. 18, 2025

(54) METHODS AND SYSTEMS OF ADJUSTING THE TEMPERATURE OF A SURFACE OF A PLASTIC CARD PRIOR TO PRINTING

(71) Applicant: ENTRUST CORPORATION, Shakopee, MN (US)

(72) Inventors: JON WAWRA, Shakopee, MN (US); BRENDAN HINNENKAMP, Shakopee, MN (US); PETE SCHMIDT, Shakopee, MN (US)

(21) Appl. No.: 19/079,105

(22) Filed: Mar. 13, 2025

Related U.S. Application Data
(60) Provisional application No. 63/565,283, filed on Mar. 14, 2024.

(51) Int. Cl. B41M 5/00; B41J 3/407; B41J 11/00; B41M 3/00

(52) U.S. Cl. CPC B41M 5/0011; B41J 3/407; B41J 11/0015; B41M 3/005; B41M 5/0064

(57) ABSTRACT

Systems and methods for improving the adhesion and durability of printing on the surfaces of plastic identification documents. This can be achieved by ensuring that the surface of the document to be printed on is at an appropriate temperature at the time of printing which helps to achieve consistent adhesion and durability of the printing from one document to the next, improves the adhesion of printing that is subsequently applied to the surface, and improves print quality. In an embodiment, a temperature sensor can be used to detect the temperature(s) of the surface prior to printing, and then based on the detected temperature, steps can be taken to ensure that the surface reaches a predetermined temperature before performing any printing on the surface.

### RELATED APPLICATION

This application claims the benefit of U.S. Provisional Application No. 63/565,283, filed Mar. 14, 2024, the disclosure of which is incorporated herein by reference.

### FIELD

This technical disclosure relates to processing personalized plastic identification documents such as personalized plastic cards and plastic pages of passports, and to controllably adjusting the temperature of at least some of the surface prior to printing to improve print adhesion and durability.

### BACKGROUND

The temperature of a surface of a plastic identification document, such as a plastic card, at the time of printing on the surface can impact the adhesion and durability of the resulting printing on the surface. The external environment where the plastic identification document printer is located, the internal environment of the plastic identification document printer that performs the printing, processing on the document that takes place prior to printing, the construction of the plastic identification document, and other factors can all impact the surface temperature before it is printed. Accordingly, from one document to the next, the temperature of the surface to be printed on can vary whereby the resulting print adhesion and durability from one plastic identification document to the next can vary.

### SUMMARY

Systems and methods are described for improving the adhesion and durability of printing on the surfaces of plastic identification documents. This can be achieved by ensuring that the surface of the document to be printed on is at an appropriate temperature at the time of printing. This helps to achieve consistent adhesion and durability of the printing from one document to the next, improves the adhesion of printing that is subsequently applied to the surface, and improves print quality. In an embodiment, a temperature sensor can be used to detect the temperature(s) of the surface prior to printing, and then based on the detected temperature, steps can be taken to ensure that the surface reaches a predetermined temperature before performing any printing on the surface.

The plastic identification documents described herein can be plastic identification cards (also referred to as plastic cards) or plastic pages of passports. Plastic cards described herein include, but are not limited to, financial (e.g., credit, debit, or the like) cards, access cards, driver's licenses, national identification cards, and business identification cards, and other plastic identification cards that can benefit from having high durable printing described herein. In an embodiment, the plastic cards may be ID-1 cards as defined by ISO/IEC 7810. However, other card formats such as ID-2 as defined by ISO/IEC 7810 are possible as well. The passport pages can be a front cover or a rear cover of the passport, or an internal page (for example a plastic page referred to as a data page) of the passport. In an embodiment, the passports may be in an ID-3 format as defined by ISO/IEC 7810. For simplicity, the following examples refer to the document as a plastic card. However, the following examples, and the concepts described in this patent application, can be applied to plastic pages of passports as well.

In one example, a method of printing on a plastic card can include inputting the plastic card into a card personalization system that includes a plastic card printing mechanism. With the plastic card in the card personalization system, a temperature of a surface of the plastic card is detected using a temperature detecting mechanism. After detecting the temperature of the surface of the plastic card, the temperature of the surface of the plastic card is altered. After altering the temperature of the surface of the plastic card, the surface of the plastic card is printed on using the plastic card printing mechanism. After printing on the surface of the plastic card, the plastic card is output from the card personalization system.

In another example, a method of printing on a plastic card can include inputting the plastic card into a card personalization system that includes a plastic card printing mechanism. With the plastic card in the card personalization system, a surface of the plastic card is heated to or above a predetermined temperature. After heating the surface of the plastic card, the surface of the plastic card is printed on using the plastic card printing mechanism. After printing on the surface of the plastic card, the plastic card is output from the card personalization system.

In another example, a plastic card personalization system can include a card input for inputting a plastic card onto a card transport path, a card output in communication with the card transport path for outputting the plastic card, and a temperature detecting mechanism that detects a temperature of a surface of the plastic card, where the temperature detecting mechanism is positioned to detect the temperature after the plastic card is input onto the card transport path from the card input. The system can also include a plastic card printing mechanism that is configured to print on the surface of the plastic card, where the plastic card printing mechanism is positioned to print on the surface after the temperature detecting mechanism detects the temperature.

### DRAWINGS

FIG. 1 schematically depicts a document personalization system described herein.

FIG. 2 schematically depicts another embodiment of a document personalization system.

FIG. 3 schematically depicts a layout of components of a document personalization system according to an embodiment.

FIG. 4 schematically depicts a layout of components of a document personalization system according to another embodiment.

FIG. 5 schematically depicts a layout of components of a document personalization system according to another embodiment.

FIG. 6 schematically depicts a layout of components of a document personalization system according to another embodiment.

FIG. 7 depicts an example of a printing method described herein.

FIG. 8 depicts another example of a printing method.

FIG. 9A is a view of an example of a front surface of a personalized plastic document in the form of a plastic card.

FIG. 9B is a view of an example of a rear surface of a personalized plastic document in the form of a plastic card.

### DETAILED DESCRIPTION

Personalized document processing systems and printing methods using such systems are described. The systems and methods described herein improve the adhesion and durability of printing on the surfaces of plastic identification documents such as plastic cards and plastic pages of passports by ensuring that the surface of the document to be printed on is at an appropriate temperature at the time of printing. This helps to achieve consistent adhesion and durability of the applied printing from one document to the next, improves the adhesion of printing that is subsequently applied to the surface, and improves print quality. In an embodiment, a temperature sensor can be used to detect the temperature(s) of the surface prior to printing, and then based on the detected temperature, proactive steps are taken ensure that the surface reaches a predetermined temperature before performing printing on the surface.

Plastic identification documents include personalized plastic identification cards and plastic pages of passports. Personalized plastic identification cards described herein include, but are not limited to, financial (e.g., credit, debit, or the like) cards, access cards, driver's licenses, national identification cards, and business identification cards, and other plastic identification cards. In an embodiment, the plastic identification cards may be ID-1 cards as defined by ISO/IEC 7810. However, other card formats such as ID-2 as defined by ISO/IEC 7810 are possible as well. The passport pages can be a front cover or a rear cover of the passport, or an internal page (for example a plastic page referred to as a data page) of the passport. In an embodiment, the passports may be in an ID-3 format as defined by ISO/IEC 7810. For the sake of simplicity in describing the concepts herein, the plastic identification documents may be described below and/or claimed as being plastic cards. However, the concepts described in this patent application can be applied to plastic pages of passports as well.

The term “plastic identification document” or “plastic identification card” as used throughout the specification and claims, unless indicated otherwise, refers to identification documents such as plastic cards where the document substrate can be formed entirely of plastic, or formed of a combination of plastic and non-plastic materials, as long as the outer layer of the card to be printed on is made of a plastic material. In one embodiment, the cards can be sized to comply with ISO/IEC 7810 with dimensions of about 85.60 by about 53.98 millimeters (about 3⅜ in×about 2⅛ in) and rounded corners with a radius of about 2.88-3.48 mm (about ⅛ in). As would be understood by a person of ordinary skill in the art of plastic identification cards, the cards are typically formed of multiple individual layers that form the majority of the card body or the card substrate. Similarly, the term “plastic page” of a passport refers to passport pages where the passport can be formed entirely of plastic, or formed of a combination of plastic and non-plastic materials. An example of a plastic passport page is the data page in a passport containing the personal data of the intended passport holder. The passport page may be a single layer or composed of multiple layers.

Examples of plastic materials that the card or passport page, or the individual layers of the card or passport can be formed from include, but are not limited to, polycarbonate, polyvinyl chloride (PVC), polyester, acrylonitrile butadiene styrene (ABS), polyethylene terephthalate glycol (PETG), TESLIN®, combinations thereof, and other plastics.

The term “processing” (or the like) as used throughout the specification and claims, unless indicated otherwise, is intended to encompass operations performed on a document that includes operations that result in personalizing the document as well as operations that do not result in personalizing the document. An example of a processing operation that personalizes the document is printing the cardholder's image or name on the document. An example of a processing operation that does not personalize the document is applying a laminate to the document or printing non-document holder graphics on the document. The term “personalize” is often used in the personalized document industry to refer to documents that undergo both personalization processing operations and non-personalization processing operations.

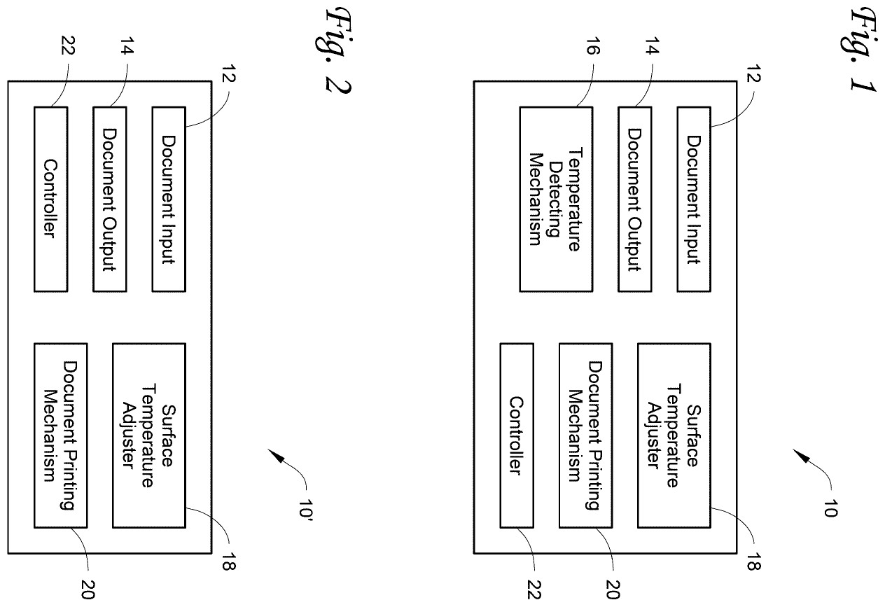

Referring to FIG. 1, an example of a document personalization system 10 is depicted. In this example, the system 10 is depicted as including a document (for example plastic card) input 12, a document output 14, a temperature detecting mechanism 16, a surface temperature adjuster 18, a document printing mechanism 20 and a controller 22. The document input 12 can be configured to hold a plurality of documents (e.g. plastic cards or passports) waiting to be processed and that mechanically feeds the documents one by one into the system 10 using a suitable document feeder. In one embodiment, the document input 12 can be an input hopper. In another embodiment, the document input 12 can be an input slot through which individual documents are manually or automatically fed for processing. The document output 14 can be configured to hold a plurality of documents after they have been processed in the system 10. In this configuration, the document output 14 is often termed a document output hopper. The construction and operation of output hoppers is well known in the art. In another embodiment, the document output 14 can be an output slot.

The temperature detecting mechanism 16 can be any device that is suitable to detect the temperature of the entire surface or a portion of the surface of a document that has been input via the document input 12. The temperature detecting mechanism 16 can be configured to contact the surface of the document in order to detect the temperature, or be configured to detect the temperature without contacting the surface. For example, the temperature detecting mechanism 16 can be a temperature probe or a thermal camera. Temperature readings from the temperature detecting mechanism 16 are provided to the controller 22 in the form of a temperature signal, and as described further below the controller 22 uses the temperature signal to generate a temperature adjustment signal that is used to alter the temperature of the surface of the document.

The surface temperature adjuster 18 is any mechanism that is capable of adjusting the temperature of the document surface to a predetermined temperature prior to printing on the surface. The adjuster 18 can be configured to heat or cool the surface. In the case of heating the surface, the adjuster 18 can be a heat gun that applies heated air to a portion of the surface or to the entire surface, an infrared heater that uses infrared energy applied to a portion of the surface or to the entire surface to heat the surface, or a mechanism that is configured to plasma treat a portion of the surface or the entire surface using a stream of charged particles. An example of a plasma treatment mechanism is described in U.S. Pat. No. 10,576,769, the entire contents of which are incorporated herein by reference. In the case of cooling the surface, the adjuster 18 can be a fan that blows air onto some or all of the surface to dissipate heat and reduce temperature, or the adjuster 18 may simply be a location in the system 10 where the document is held stationary or “parked” for a period of time to allow the surface to cool down.

The document printing mechanism 20 is a mechanism that is configured to apply printing to a portion of or the entire surface of the document. Examples of printing that can be used include, but are not limited to, drop-on-demand (DOD) printing using ink, which may be curable by ultraviolet radiation, applied to the surface from one or more DOD print heads; direct-to-document thermal transfer printing where dye or other color material or other material is applied from one or more print ribbons via a thermal print head to the surface; or retransfer printing where an image is first printed on an intermediate material which is then transferred to the surface. An example of a DOD printer is described in U.S. Pat. No. 10,576,769 the entire contents of which are incorporated herein by reference. An example of a thermal transfer printer is described in U.S. Pat. No. 10,889,129 the entire contents of which are incorporated herein by reference. An example of a retransfer printer is described in U.S. Pat. No. 9,904,876 the entire contents of which are incorporated herein by reference.

The controller 22 is any arrangement of hardware and/or software that controls operation of the system 10 including the components 12, 14, 16, 18, and 20. In particular, the controller 22 receives the temperature signal from the temperature detecting mechanism 16 and based on the temperature signal generates a temperature adjustment signal that controls the adjuster 18 to adjust the temperature of the surface so that the surface reaches a predetermined temperature prior to printing on the surface by the printing mechanism 20.

The components 12-22 of the system 10 are depicted as being surrounded by a box indicating that all of the components 12-22 are an integral part of the system 10. The system 10 can have any form suitable for personalizing documents. For example, the system 10 can be configured as a large volume batch production document processing system (sometimes referred to as a central issuance processing system) that can be used to process plastic identification documents described herein. A large volume batch production document processing system is configured to process multiple documents at the same time, with the documents being processed in sequence, with the documents proceeding generally along a document transport direction/transport path. A large volume batch production document processing system typically processes documents in high volumes, for example on the order of high hundreds or thousands per hour, and employs multiple processing stations or modules to process multiple documents at the same time to reduce the overall per document processing time. Examples of such large volume document processing machines include the MX and MPR family of central issuance processing machines available from Entrust Corporation of Shakopee, Minnesota. Other examples of central issuance processing machines are disclosed in U.S. Pat. Nos. 4,825,054, 5,266,781, 6,783,067, and 6,902,107, all of which are incorporated herein by reference in their entirety.

The system 10 can also be configured as a desktop document processing system that is typically designed for relatively smaller scale, individual document personalization in relatively small volumes, for example measured in tens or low hundreds per hour, often time with a single document being processed at any one time. These document processing machines are often termed desktop processing machines because they have a relatively small footprint intended to permit the processing machine to reside on a desktop. Many examples of desktop processing machines are known, such as the SIGMA™ and ARTISTA™ family of desktop card printers available from Entrust Corporation of Shakopee, Minnesota. Other examples of desktop processing machines are disclosed in U.S. Pat. Nos. 7,434,728 and 7,398,972, each of which is incorporated herein by reference in its entirety.

The system 10 in FIG. 1 can include just the components 12-22, or the system 10 can include additional components discussed below with respect to FIG. 6.

Referring to FIG. 2, another example of a document personalization system 10′ is depicted. In this example, components that are that same as or substantially similar in function (and possibly even construction) to components in FIG. 1 are referenced using the same reference numerals. The system 10′ is depicted as including the document (for example plastic card) input 12, the document output 14, the surface temperature adjuster 18, the document printing mechanism 20 and the controller 22. The system 10′ may optionally include a temperature detecting mechanism like the temperature detecting mechanism 16 in FIG. 1.

In the example in FIG. 2, the system 10′ can operate without a temperature detecting mechanism as long as the surface temperature adjuster 18 can be suitably controlled so that the surface of the document controllably reaches a predetermined temperature. For example, the adjuster 18 can be a heater that heats the surface to or above a predetermined temperature as long as one knows that each document reaches the predetermined temperature.

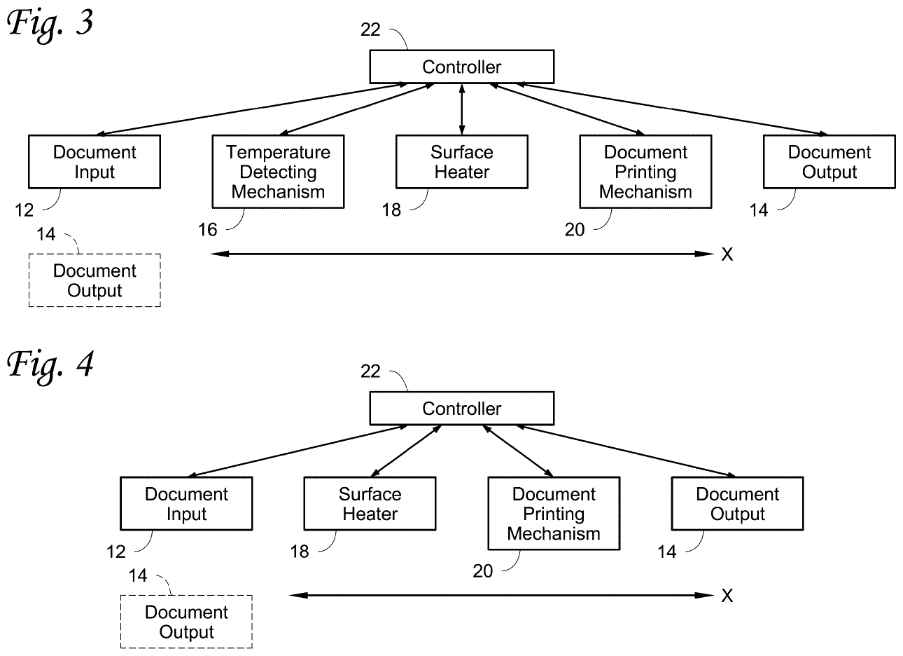

FIG. 3 illustrates an example arrangement of the components 12-22 of FIG. 1. In this example, the components 12-20 are depicted as arranged as a large volume batch production document processing system with the document input 12 and the document output 14 at opposite ends, the components 16-20 arranged between the input 12 and the output 14, and the documents transported by suitable transport mechanisms along a generally linear document transport path X. The adjuster 18 is also labeled as a surface heater although the adjuster 18 could also be configured to cool the surface. The documents can be transported in a forward direction (i.e. in a direction toward the output 14) along the transport path X and optionally in a reverse direction (toward the input 12). In this example, the temperature detecting mechanism 16 is between the input 12 and the output 14. The mechanism 16 is also downstream of the input 12 but upstream of the heater 18. The heater 18 is between the input 12 and the output 14, and the heater 18 is between the temperature detecting mechanism 16 and the printing mechanism 20. The printing mechanism 20 is between the input 12 and the output 14, the printing mechanism 20 is downstream of the temperature detecting mechanism 16 and the heater 18, and the printing mechanism 20 is between the heater 18 and the output 14. The controller 22 can be located anywhere as long as it can be connected to and control the components 12-20.

FIG. 3 depicts an alternative location of the output 14 (depicted in broken lines), for example at the same end as the input 12, or the input 12 and the output 14 could have other relative positioning to one another. Such alternative positioning of the input 12 and/or the output 14 would be suitable when arranging the components 12-20 as a desktop document processing system.

FIG. 4 illustrates an example arrangement of the components 12-22 of FIG. 2. In this example, the components 12-20 are depicted as arranged as a large volume batch production document processing system with the document input 12 and the document output 14 at opposite ends, the components 18-20 arranged between the input 12 and the output 14, and the documents transported by suitable transport mechanisms along a generally linear document transport path X. The adjuster 18 is also labeled as a surface heater although the adjuster 18 could also be configured to cool the surface. The documents can be transported in a forward direction (i.e. in a direction toward the output 14) along the transport path X and optionally in a reverse direction (toward the input 12). In this example, the heater 18 is between the input 12 and the output 14, and the heater 18 is between the input 12 and the printing mechanism 20. The printing mechanism 20 is between the input 12 and the output 14, the printing mechanism 20 is downstream of the heater 18, and the printing mechanism 20 is between the heater 18 and the output 14. The controller 22 can be located anywhere as long as it can be connected to and control the components 12, 14, 18, 20.

FIG. 4 depicts an alternative location of the output 14 (depicted in broken lines), for example at the same end as the input 12, or the input 12 and the output 14 could have other relative positioning to one another. Such alternative positioning of the input 12 and/or the output 14 would be suitable when arranging the components 12, 14, 18, 20 as a desktop document processing system.

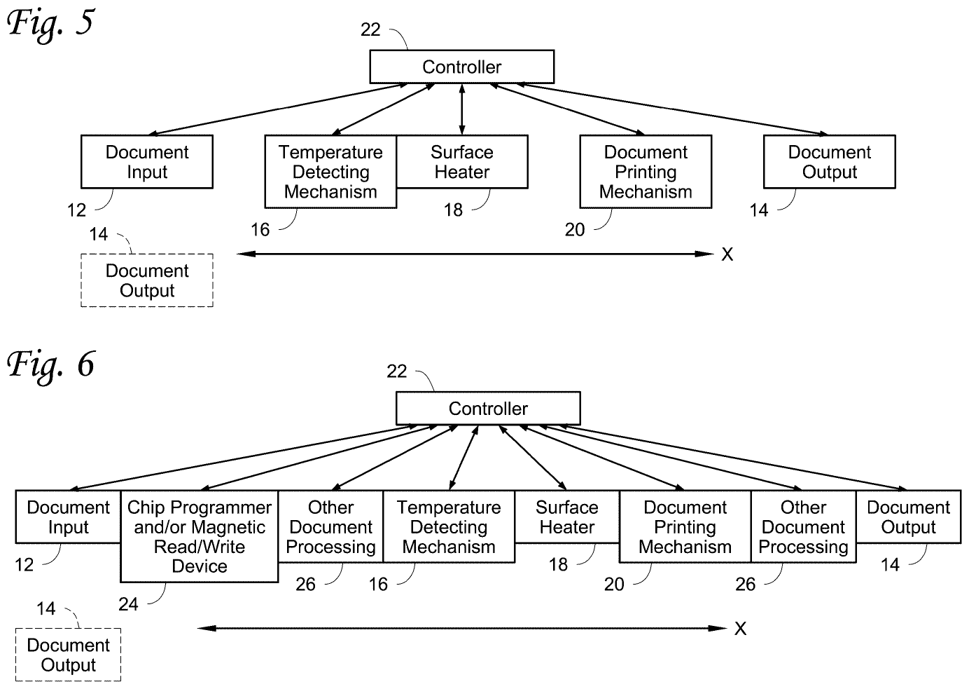

FIG. 5 illustrates another example arrangement of the components 12-22 of FIG. 1. In this example, the components 12-20 are depicted as arranged as a large volume batch production document processing system with the document input 12 and the document output 14 at opposite ends, the components 16-20 arranged between the input 12 and the output 14, and the documents transported by suitable transport mechanisms along the generally linear document transport path X. The adjuster 18 is also labeled as a surface heater although the adjuster 18 could also be configured to cool the surface. The documents can be transported in a forward direction (i.e. in a direction toward the output 14) along the transport path X and optionally in a reverse direction (toward the input 12). In this example, the temperature detecting mechanism 16 and the heater 18 are depicted as being integrated together into a single unit. In this example, the temperature detecting mechanism 16 is between the input 12 and the output 14. The mechanism 16 is also downstream of the input 12 but upstream of the heater 18. The heater 18 is between the input 12 and the output 14, and the heater 18 is between the temperature detecting mechanism 16 and the printing mechanism 20. The printing mechanism 20 is between the input 12 and the output 14, the printing mechanism 20 is downstream of the temperature detecting mechanism 16 and the heater 18, and the printing mechanism 20 is between the heater 18 and the output 14. The controller 22 can be located anywhere as long as it can be connected to and control the components 12-20. FIG. 5 also shows the alternative location of the output 14 in broken lines which is suitable when arranging the components 12-20 as a desktop document processing system.

FIG. 6 illustrates another example arrangement of the components 12-22 of FIG. 1 together with additional components. A similar arrangement can be utilized with the components of FIG. 2. In addition to the components 12-22 described above, the system in FIG. 6 is also depicted as including a chip testing/programmer and/or a magnetic strip encoder 24. The chip testing/programmer is configured to perform contact or contactless testing of an integrated circuit chip on each document to test the functionality of the chip, as well as program the chip. Testing the functionality of the chip can include reading data from and/or writing data to the chip. In one embodiment, the chip testing/programming device can be configured to simultaneously program the chips on a plurality of cards. The construction and operation of chip testing/programming devices in document processing systems is well known in the art. The magnetic strip read/write testing device (when the documents are plastic cards) is configured to read data from and/or encode data on a magnetic strip on each card (if the plastic cards include a magnetic strip). The construction and operation of magnetic strip read/write testing devices in document processing systems is well known in the art.

The system in FIG. 6 may also include optional other document processing mechanism(s) 26. One or more of the mechanism(s) 26 may be located between the mechanism 24 and the temperature detecting mechanism 16, and/or one or more of the mechanism(s) 26 may be located between the printing mechanism 20 and the output 14. The mechanism(s) 26 can be processing mechanisms known in the art to perform processing operations that are known in the art. For example, the processing mechanism(s) 26 can be configured to perform one or more of embossing; indenting; laminating; laser marking using a laser; apply a topcoat; a quality control station that is configured to check the quality of personalization/processing applied to the documents; a radiation curing station to apply radiation to cure radiation curable ink; a security station that is configured to apply a security feature such as a holographic foil patch to the cards; and other document processing operations.

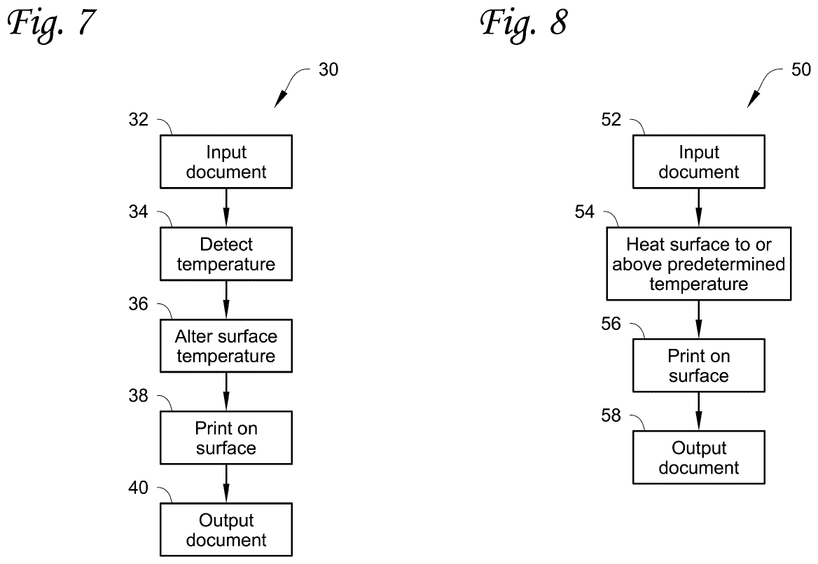

FIG. 7 depicts an example of a printing method 30 using the system 10 in FIG. 1. In the method 30, a document is input at step 32 onto the transport path X from the input 12. With the document in the system 10 and the document transported to an appropriate location in the system, a temperature of a surface of the document is detected at step 34 using the temperature detecting mechanism. The temperature of the entire surface or a portion of the surface can be detected. In an embodiment, the temperature detecting mechanism can be located at a position in the system to detect the temperature of the surface without requiring transport of the document from its immediate location after being introduced from the input 12. However, one or more processing steps on the document can take place prior to the temperature detection. For example, in the case of some plastic cards, a chip on the plastic card can be tested and/or programmed, and/or a magnetic strip can be encoded with data, prior to the temperature detection.

At step 36, after detecting the temperature of the surface of the document and with the document still in the system, the document is transported to the temperature adjuster and the temperature of the surface of the document is altered (heated or cooled). For example, in the case of heating, heat can be applied to some or all of the surface of the document by the heater to increase the temperature of the surface to or above a predetermined temperature. In an embodiment, the predetermined temperature may be in a range from 30-80° C. including the end points. In another embodiment, the predetermined temperature may be in a range from 35-75° C. including the end points. In another embodiment, the predetermined temperature may be in a range from 45-65° C. including the end points. Other temperature ranges are possible. If the temperature detection determines that the temperature is already at the desired level, the document can be transported to the document printing mechanism without any intentional temperature adjustment occurring in the temperature adjuster.

In an embodiment, after the temperature adjustment, the temperature of the surface may be substantially uniform over the entire surface. Substantially uniform as used herein means that the variation in temperature over the surface is less than or equal to 10%. However, the temperature of the surface need not be substantially uniform over the entire surface. Rather, the temperature may vary over the surface of the document as long as the temperatures are at a level to provide the desired enhanced print adhesion and durability described herein.

Optionally, after adjusting the temperature, the temperature of the surface of the document can again be detected, for example using the temperature detecting mechanism or a second temperature detecting mechanism which can be located downstream of the temperature adjuster. If the adjusted temperature is not suitable, the temperature of the document surface can again be altered, for example using the temperature adjuster or a second temperature adjuster. This iterative process of temperature detection and alteration of the surface temperature can be repeated any number of times until the surface temperature is at the predetermined level. In an embodiment, the temperature detection can occur at the same location as the temperature adjustment (for example, the temperature detecting mechanism and the temperature adjuster can be integrated together) whereby the document does not need to be transported to the temperature adjuster after the temperature detection.

At step 38, after the temperature of the surface of the document is altered to reach the predetermined temperature, the document is transported into the printing mechanism and the surface of the document is printed on using the printing mechanism. Printing can be performed using any suitable printing technique where adhesion of the printing is improved by the temperature of the document surface being at a predetermined level, such as one of the printing techniques described above. In an embodiment, printing on the document surface occurs as soon as possible after the surface of the document has reached the predetermined temperature to maximize the benefits of enhanced print adhesion and durability. This means that it is preferred that the document does not undergo any other processing between the time of temperature adjustment (and reaching the desired temperature) and printing on the surface. However, if the desired temperature of the document surface can be maintained by the time the surface is printed on, then additional processing on the document can occur between the time of temperature adjustment (and reaching the desired temperature) and printing on the surface.

At step 40, after printing on the surface of the document, the document is output into the document output 14. In an embodiment, additional processing can occur on the document between completion of printing and outputting the document. For example, the document can be flipped 180 degrees in a document flipper and printing and/or other processing can occur on the opposite surface of the document for example by redirecting the document back through the prior mechanisms or duplicating the mechanisms downstream of the printing mechanism, the quality of the printing and other processing on the document can be checked in a quality control mechanism, or other processing can occur.

FIG. 8 depicts an example of a printing method 50 using the system 10′ in FIG. 2. The method 50 is for example suitable in instances where one can controllably heat the document surface in a manner where one knows that the desired temperature of the document surface is reached without requiring temperature detection of the document surface. In the method 50, a document is input at step 52 onto the transport path X from the input 12. The document is transported to the temperature adjuster and the document surface is heated (or optionally cooled) at step 54. For example, heat can be applied to some or all of the surface of the document by the heater to increase the temperature of the surface to or above a predetermined temperature. The predetermined temperature may be within one of the temperature ranges described above or within a different temperature range. However, one or more processing steps on the document can take place prior to heating the document surface. For example, in the case of some plastic cards, a chip on the plastic card can be tested and/or programmed, and/or a magnetic strip can be encoded with data, prior to heating the document surface.

In an embodiment, after the heating, the temperature of the surface may be substantially uniform over the entire surface. Substantially uniform as used herein means that the variation in temperature over the surface is less than or equal to 10%. However, the temperature of the surface need not be substantially uniform over the entire surface. Rather, the temperature may vary over the surface of the document as long as the temperatures are at a level to provide the desired enhanced print adhesion and durability described herein.

At step 56, after the temperature of the surface of the document is heated to reach the predetermined temperature, the document is transported into the printing mechanism and the surface of the document is printed on using the printing mechanism. Printing can be performed using any suitable printing technique where adhesion of the printing is improved by the temperature of the document surface being at a predetermined level, such as one of the printing techniques described above. In an embodiment, printing on the document surface occurs as soon as possible after the surface of the document has reached the predetermined temperature to maximize the benefits of enhanced print adhesion and durability. This means that it is preferred that the document does not undergo any other processing between the time of heating the surface (and reaching the desired temperature) and printing on the surface. However, if the desired temperature of the document surface can be maintained by the time the surface is printed on, then additional processing on the document can occur between the time of heating (and reaching the desired temperature) and printing on the surface.

At step 58, after printing on the surface of the document, the document is output into the document output 14. In an embodiment, additional processing can occur on the document between completion of printing and outputting the document. For example, the document can be flipped 180 degrees in a document flipper and printing and/or other processing can occur on the opposite surface of the document for example by redirecting the document back through the prior mechanisms or duplicating the mechanisms downstream of the printing mechanism, the quality of the printing and other processing on the document can be checked in a quality control mechanism, or other processing can occur.

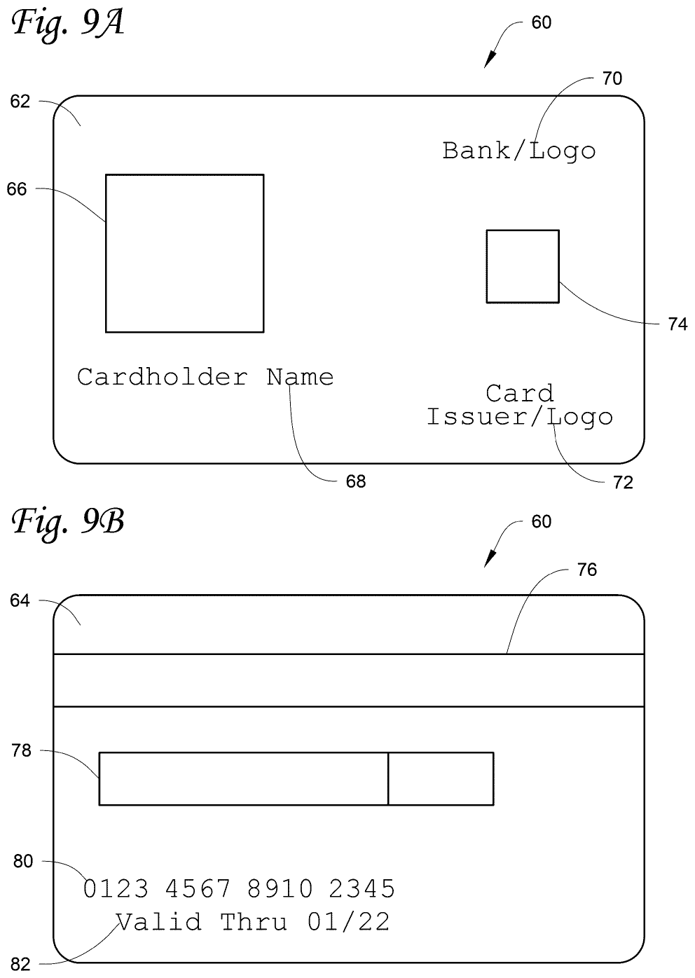

FIGS. 9A and 9B illustrate an example of a plastic identification document in the form of a plastic card 60. In this example, the card 60 is shown to include a front or first surface 62 (FIG. 9A) and a rear, back or second surface 64 (FIG. 9B) opposite the front surface 62. The card 60 may be printed on one side only (referred to as simplex printing), for example on the front surface 62 or the rear surface 64, or printed on both sides (referred to as duplex printing), for example on each of the front surface 62 and the rear surface 64.

Many possible layouts for the front surface 62 are possible. For example, the front surface 62 can include a horizontal card layout, a vertical card layout, and other known layout configurations and orientations. In the illustrated example in FIG. 9A, the front surface 62 can include various printed cardholder data such as a printed portrait image 66, the cardholder name 68, and account information such as account number, expiration date and the like. The front surface 62 can also include other printed data such as printed information 70 of the entity that issued the card 60, such as the corporate name and/or logo of the issuing bank (for example, STATE BANK), and/or printed information 72 of the card brand name (for example, VISA®, MASTERCARD®, DISCOVER®, etc.). The front surface 62 may also include a contact or contactless integrated circuit chip 74 that can store various data relating to the card 60 such as an account number and/or name of the cardholder.

Referring to FIG. 9B, many possible layouts for the rear surface 64 are possible which may or may not have a similar layout as the front surface 62. For example, the rear surface 64 can include a horizontal card layout, a vertical card layout, and other known layout configurations and orientations. In the illustrated example in FIG. 9B, the rear surface 64 can include a magnetic strip 76 that stores various data relating to the card 60 such as an account number or name of the cardholder, a signature panel 78 that provides a place for the cardholder to sign their name, and a hologram. The magnetic strip 76, the signature panel 78, and the hologram are conventional elements found on many plastic cards. The rear surface 64 can also include printed personal data that is unique to or assigned specifically to the cardholder. For example, an account number 80 assigned to the cardholder, the name of the cardholder, and a card expiration date 82 can be printed on the rear surface 64. Other personal cardholder data may also be printed on the rear surface 64, such as an image of the face of the cardholder. Non-personal data such as the name of the issuing bank, contact information to contact the issuing bank, and the like, can also be printed on the rear surface 64. The printing 66, 68, 70, 72, 80, 82 may each individually be referred to as a printed image or printed data.

Some or all of the printing on the front surface 62 and/or the printing on the rear surface 64 may be partially overlapped or completely overlapped by a material designed to enhance the durability (for example, abrasion resistance, chemical resistance, and adhesion) of the printing compared to the durability of printing that is not overlapped by the material. The enhanced durability is sufficient to permit the plastic card 60 to be issued to the cardholder without a protective laminate or coating applied over the entire front surface 62 and/or over the entire rear surface 64. However, in an embodiment, a protective laminate or coating can be applied to overlay the entire front surface 62 and/or the entire rear surface 64.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of printing on a plastic card, comprising:
inputting the plastic card into a card personalization system that includes a plastic card printing mechanism;
with the plastic card in the card personalization system, detecting a temperature of a surface of the plastic card using a temperature detecting mechanism;
after detecting the temperature of the surface of the plastic card, altering the temperature of the surface of the plastic card;
after altering the temperature of the surface of the plastic card, printing on the surface of the plastic card using the plastic card printing mechanism; and
after printing on the surface of the plastic card, outputting the plastic card from the card personalization system.

2. The method of claim 1, wherein detecting the temperature of the surface of the plastic card comprises detecting the temperature of the entire surface or a portion of the surface.

3. The method of claim 1, wherein after detecting the temperature of the surface of the plastic card, transporting the plastic card into the plastic card printing mechanism.

4. The method of claim 1, wherein altering the temperature of the surface of the plastic card comprises heating the surface of the plastic card to increase the temperature of the surface of the plastic card.

5. The method of claim 4, wherein heating the surface of the plastic card comprises heating the surface of the plastic card to or above a predetermined temperature.

6. The method of claim 4, wherein heating the surface of the plastic card comprises heating the surface of the plastic card using heated air, an infrared heater, or a plasma.

7. The method of claim 4, wherein heating the surface of the plastic card comprises heating the entire surface of the plastic card or heating a portion of the surface of the plastic card.

8. The method of claim 1, wherein printing on the plastic card comprises drop-on-demand printing, retransfer printing, or direct-to-card thermal printing.

9. The method of claim 1, comprising transmitting a temperature signal from the temperature detecting mechanism to a controller in the card personalization system, and the controller generating a temperature adjustment signal based on the temperature signal that is used to alter the temperature of the surface of the plastic card.

10. A method of printing on a plastic card, comprising:
inputting the plastic card into a card personalization system that includes a plastic card printing mechanism;
with the plastic card in the card personalization system, heating a surface of the plastic card to or above a predetermined temperature;
after heating the surface of the plastic card, printing on the surface of the plastic card using the plastic card printing mechanism; and
after printing on the surface of the plastic card, outputting the plastic card from the card personalization system.

11. The method of claim 10, wherein after heating the surface of the plastic card, transporting the plastic card into the plastic card printing mechanism.

12. The method of claim 10, wherein heating the surface of the plastic card comprises heating the surface of the plastic card using heated air, an infrared heater, or a plasma.

13. The method of claim 10, wherein heating the surface of the plastic card comprises heating the entire surface of the plastic card or heating a portion of the surface of the plastic card.

14. The method of claim 10, wherein printing on the surface of the plastic card comprises drop-on-demand printing, retransfer printing, or direct-to-card thermal printing.

15. A plastic card personalization system, comprising:
a card input for inputting a plastic card onto a card transport path;
a card output in communication with the card transport path for outputting the plastic card;
a temperature detecting mechanism that detects a temperature of a surface of the plastic card, the temperature detecting mechanism is positioned to detect the temperature after the plastic card is input onto the card transport path from the card input;
a plastic card printing mechanism configured to print on the surface of the plastic card, the plastic card printing mechanism is positioned to print on the surface after the temperature detecting mechanism detects the temperature.

16. The plastic card personalization system of claim 15, wherein the temperature detecting mechanism and the plastic card printing mechanism are disposed on the card transport path, and the temperature detecting mechanism is located on the card transport path upstream of the plastic card printing mechanism.

17. The plastic card personalization system of claim 15, further comprising a heater that is configured to heat at least a portion of the surface of the plastic card, the heater is positioned to heat at least a portion of the surface after the temperature detecting mechanism detects the temperature.

18. The plastic card personalization system of claim 17, further comprising a controller in communication with the temperature detecting mechanism and with the heater, the temperature detecting mechanism is configured to send a temperature signal to the controller, and the controller is configured to generate and send a temperature adjustment signal to the heater based on the temperature signal.

19. The plastic card personalization system of claim 17, wherein the heater comprises a heat gun that generates a flow of heated air, an infrared heater, or a plasma generator.

20. The plastic card personalization system of claim 17, wherein the plastic card printing mechanism is configured to perform drop-on-demand printing, retransfer printing, or direct-to-card thermal printing.
